(19) United States
(12) Patent Application Publication
(10) Pub. No.: US 2015/0125234 A1
(43) Pub. Date: May 7, 2015

(54) DIRECT TENSION INDICATING WASHER

(71) Applicant: Applied Bolting Technology, Bellows Falls, VT (US)

(72) Inventors: Barnaby Myhrum, Saxtons River, VT (US); Michael Howerin, Meriden, NH (US)

(21) Appl. No.: 14/399,022

(22) PCT Filed: May 6, 2013
(86) PCT No.: PCT/US2013/039674

§ 371 Date: Nov. 5, 2014

Related U.S. Application Data
(60) Provisional application No. 61/643,437, filed on May 7, 2012.

(51) Int. Cl. F16B 31/02

(52) U.S. Cl. CPC F16B 31/028
USPC 411/14

(57) ABSTRACT

A direct tension indicating washer includes a body having a first surface having a protuberance formed thereon; the body having a second surface having an indentation formed opposite the protuberance; an indicating material positioned in the indentation; and a channel formed in the second surface, the channel coupling the indentation to an outer edge of the body; wherein at least one of (i) a ratio of h/t is in a range of about 0.5 to about 0.8, (ii) a ratio of S/DW is in a range of about 0.2 to about 0.3 and (iii) a ratio of DSM/SSM is in a range of about 0.4 to about 0.6, is satisfied; wherein t is a thickness of the body, S is a length of the channel, h is a height of the protrusion, DW is a width of the indentation taken along a radius, DSM is an amount of indicating material that is emitted into the channel upon reaching a predetermined bolt tension and SSM is an amount of indicating material that remains in the indentation upon reaching a predetermined bolt tension.

### BACKGROUND

Embodiments relate generally to direct tension indicating washers and in particular to direct tension indicating washers providing enhanced visibility of indicating material in low load applications.

Direct tension indicating washers are used in the art to indicate when proper bolt tension has been reached. U.S. Pat. No. 5,931,618, the entire contents of which are incorporated herein by reference, discloses an exemplary direct tension indicating washer. FIG. 1 is a top view of the direct tension indicating washer from U.S. Pat. No. 5,931,618. A direct tension indicating washer 60 includes protuberances 12 formed on a first surface 14 and corresponding indentations 16 formed on a second surface 18 opposite the protuberances 12. The direct tension indicating washer 60 also includes channels 62 that lead from each indentation 16 to the outer diameter of the direct tension indicating washer 60. The indentation 16 is filled with an indicating material 64. The direct tension indicating washer 60 is manufactured using a tool and die to stamp the protuberances 12, indentations 16 and channels 62 into a blank washer. Other processes, such as metal machining, electronic printing, or metal casting may be used to form the direct tension indicating washer 60. Direct tension indicating washer 60 is made from carbon steel, but stainless steel, nonferrous metals, and other alloy products may also be used. The indicating material 64 is an extrudable, elastomeric solid material such as colored silicone. FIG. 2 is a cross-sectional view taken along line 2-2 of FIG. 1.

While the direct tension indicating washer of FIGS. 1-2 is well suited for its intended purposes, there is a need for improving visibility of the emission of indicating material under certain conditions. Conventional direct tension indicating washers are made to suit the intended installed tensions of high strength structural bolts, between 70% and 84% of their minimum ultimate breaking strength, as stipulated by structural steel codes and standards worldwide. Direct tension indicating washers of the type in U.S. Pat. No. 5,931,618 are similarly designed to show a repeatable volume and appearance of bright colored silicone indicating material at bolt tensions within this bolt tension range.

A direct tension indicating washer for much lower bolt tension applications (10 to 20 percent of minimum ultimate breaking strength) is needed for applications such as mine roof bolts, flange bolting where metallic DTIs are necessary, etc., and will enable significantly more uniform and accurate bolt installation for these applications. Until now it has not been possible to make such a product using a metallic substrate. At the same time, these applications require functionality in very low light situations, necessitating the emission of a large quantity of high-visibility indicating material for enhanced appearance in low-light applications.

### SUMMARY

Embodiments of the invention include a direct tension indicating washer including a body having a first surface having a protuberance formed thereon; the body having a second surface having an indentation formed opposite the protuberance; an indicating material positioned in the indentation; and a channel formed in the second surface, the channel coupling the indentation to an outer edge of the body; wherein at least one of (i) a ratio of h/t is in a range of about 0.5 to about 0.8, (ii) a ratio of S/DW is in a range of about 0.2 to about 0.3 and (iii) a ratio of DSM/SSM is in a range of about 0.4 to about 0.6, is satisfied; wherein t is a thickness of the body, S is a length of the channel, h is a height of the protrusion, DW is a width of the indentation taken along a radius, DSM is an amount of indicating material that is emitted into the channel upon reaching a predetermined bolt tension and SSM is an amount of indicating material that remains in the indentation upon reaching a predetermined bolt tension.

Other features of embodiments of the invention are described herein.

### BRIEF DESCRIPTION OF THE DRAWINGS

Referring now to the drawings wherein like elements are numbered alike in the several Figures:

FIG. 1 is a top view of a conventional direct tension indicating washer;

FIG. 2 is a cross-sectional view of the direct tension indicating washer shown in FIG. 1 taken along line 2-2;

FIG. 3 cross-sectional view a direct tension indicating washer in exemplary embodiments; and

FIG. 4 depicts dynamic indicating material and static indicating material for a conventional direct tension indicating washer and direct tension indicating washer in an embodiment.

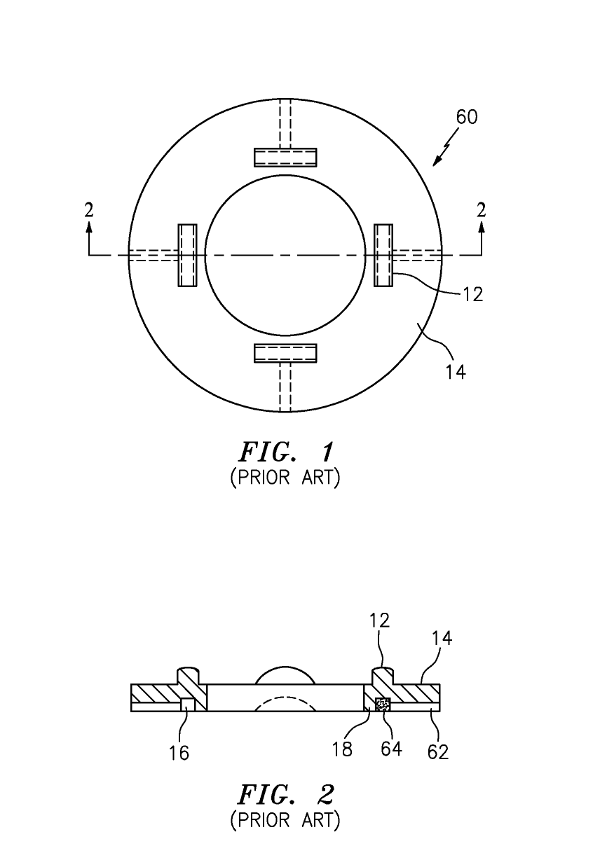

### DETAILED DESCRIPTION

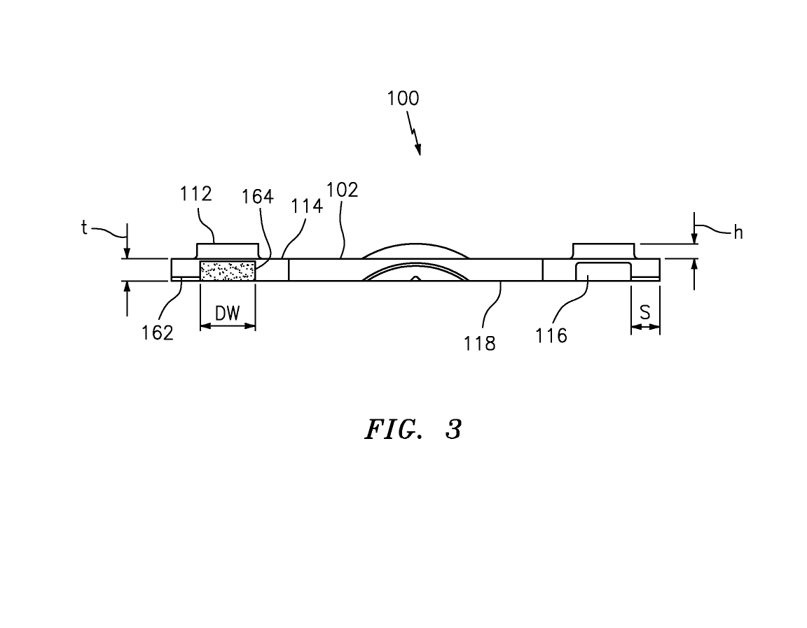

Embodiments of the invention related to a direct tension indicating washer. FIG. 3 cross-sectional view a direct tension indicating washer 100 in exemplary embodiments. Direct tension indicating washer 100 includes a body 102 having protuberances 112 formed on a first surface 114 and corresponding indentations 116 formed on a second surface 118 opposite the protuberances 112. The direct tension indicating washer 100 also includes channels 162 that lead from each indentation 116 to the outer diameter of the direct tension indicating washer 100. The indentation 116 is filled with an indicating material 164. The indicating material 164 is an extrudable, elastomeric solid material such as colored silicone. The indicating material 164 may be colored to be more readably viewable under low light conditions (e.g., bright green color). Direct tension indicating washer 100 may include features from U.S. Pat. No. 6,425,718, U.S. Patent Application Publication 20080138167, U.S. Pat. No. 7,857,562 and U.S. Patent Application Publication 20110123288, the entire contents of all these publications are incorporated herein by reference.

Custom low loads are achieved by precision stamping body 102 from very thin and soft material such as annealed steel, copper, brass, or similar metals in such a way that the substrate metal is not torn or fractured. In this way a very high protrusion 112 relative to the substrate 102 thickness is formed, and at the same time the protrusion 112 is sized and located so as to make a very short squirt channel 162 length. It is the combination of very large volume of elastomeric material 164 under each protrusion 112, very high protrusion 112, and very short channel 162, that forces the dynamic emission of a large amount of elastomeric material 164, relative to the volume of elastomeric material 164 deposited under each protrusion.

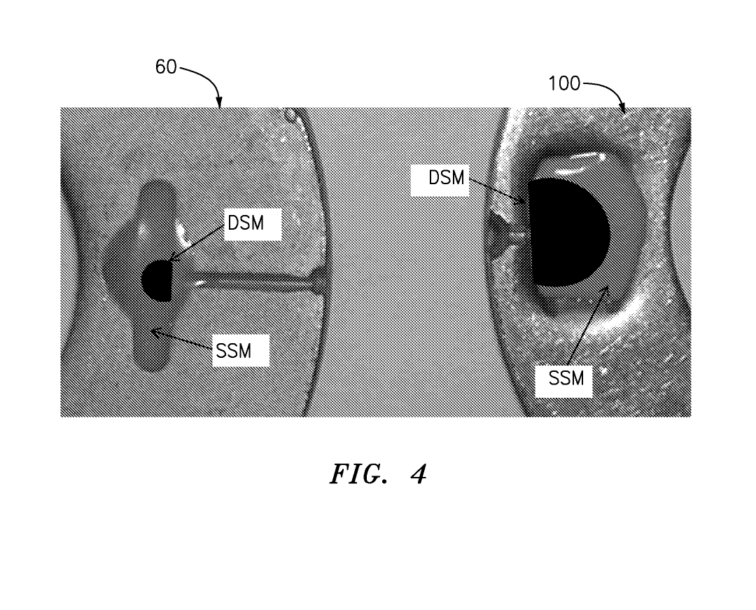

The portion of the elastomeric material 164 under each protrusion 112 which is ejected as the protrusion is compressed is referred to as “dynamic squirt media” (DSM), and the remaining portion is referred to as the “static squirt media” (SSM). FIG. 4 illustrates DSM and SSM for both a conventional direct tension indicating washer 60 and direct tension indicating washer 100 in embodiments of the invention.

The following table of typical parametric ratios will illustrate the differences between conventional direct tension indicating washer of FIG. 1 and embodiments of the invention as shown in FIG. 3.

| | h/t | S/DW | DSM/SSM |
|---|---|---|---|
| Standard DTI of | About 0.2 to | About 4 to about 6 | About 0.1 to |
| FIG. 1 | about 0.4 | | about 0.3 |
| DTI of FIG. 3 | About 0.5 to | About 0.2 to | About 0.4 to |
| | about 0.8 | about 0.3 | about 0.6 |

Value t is the material thickness of body 102, value S is the length of channel 162, value h is the height of protrusion 112, DW is the width of the indentation 116 taken along a radius of the direct tension indicating washer 100, DSM is an amount (e.g., volume or weight) of indicating material 164 that is emitted into channel 162 upon reaching a predetermined bolt tension, and SSM is an amount (e.g., volume or weight) of indicating material 164 that remains in indentation 116 upon reaching a predetermined bolt tension. As known in the art, direct tension indicating washer 100 is designed to emit indicating material at the outer edge of body 102 when bolt tension reaches a desired level, which varies depending on application.

The volume of indentation 116 and indicating material 164 is selected to provide a highly visible squirt event (e.g., emission of indicating material 164 at the outer edge of body 102) at low loads. This occurs because the ratio of DSM/SSM is higher than standard direct tension indicating washers, and the indentation 116 is located closer to the outer diameter of body 102 relative to standard direct tension indicating washers, resulting in a very short channel 162, and the consequent wide and highly visible emitted indicating material 164.

While preferred embodiments have been shown and described, various modifications and substitutions may be made thereto without departing from the spirit and scope of the invention. For example, the centering elements may be used with conventional, non-squirting, direct tension indicating washers. Accordingly, it is to be understood that the present invention has been described by way of illustration and not limitation.

What is claimed is:

1. A direct tension indicating washer comprising:
a body having a first surface having a protuberance formed thereon;
the body having a second surface having an indentation formed opposite the protuberance;
an indicating material positioned in the indentation; and
a channel formed in the second surface, the channel coupling the indentation to an outer edge of the body;
wherein at least one of (i) a ratio of h/t is in a range of about 0.5 to about 0.8, (ii) a ratio of S/DW is in a range of about 0.2 to about 0.3 and (iii) a ratio of DSM/SSM is in a range of about 0.4 to about 0.6, is satisfied;
wherein t is a thickness of the body, S is a length of the channel, h is a height of the protrusion, DW is a width of the indentation taken along a radius, DSM is an amount of indicating material that is emitted into the channel upon reaching a predetermined bolt tension and SSM is an amount of indicating material that remains in the indentation upon reaching a predetermined bolt tension.

2. The direct tension indicating washer of claim 1 wherein:
wherein at least two of (i) a ratio of h/t is in a range of about 0.5 to about 0.8, (ii) a ratio of S/DW is in a range of about 0.2 to about 0.3 and (iii) a ratio of DSM/SSM is in a range of about 0.4 to about 0.6, is satisfied.

3. The direct tension indicating washer of claim 1 wherein:
(i) a ratio of h/t is in a range of about 0.5 to about 0.8, (ii) a ratio of S/DW is in a range of about 0.2 to about 0.3 and (iii) a ratio of DSM/SSM is in a range of about 0.4 to about 0.6.
